(19) United States
(12) Patent Application Publication
(10) Pub. No.: US 2015/0203138 A1
(43) Pub. Date: Jul. 23, 2015

(54) DOLLY FOR PALLET

(71) Applicant: Rehrig Pacific Company, Los Angeles, CA (US)

(72) Inventors: Jon P. Hassell, Atlanta, GA (US); Philip King, Sugar Hill, GA (US)

(21) Appl. No.: 14/324,773

(22) Filed: Jul. 7, 2014

Related U.S. Application Data
(60) Provisional application No. 61/843,219, filed on Jul. 5, 2013.

(51) Int. Cl. B62B 3/04; B62B 3/00; B65D 19/00

(52) U.S. Cl. CPC B62B 3/04; B65D 19/004; B62B 3/008; B65D 2519/00268; B65D 2519/0094

(57) ABSTRACT

A dolly includes a base and a plurality of wheels supporting the base. At least one locking device removably secures a pallet to the base. The at least one locking device includes a pin for securing a deck of the pallet between the pin and the base. The pin is received in a notch along an upper edge of the deck.

### BACKGROUND

One type of pallet, typically used for delivery of beverage containers to stores, includes a relatively long and narrow deck. A plurality of supports (such as six) extend downward from the deck. The supports (or columns) are spaced inward from the side edges and end edges of the deck. The pallet can be handled and delivered on a pallet lift jack or fork lift.

### SUMMARY

A dolly according to one embodiment of the present invention includes a base and a plurality of wheels supporting the base. At least one locking device removably secures a pallet to the base. The at least one locking device includes a pin for securing a deck of the pallet between the pin and the base. The pin is received in a notch along an upper edge of the deck.

In the disclosed embodiment, one dolly supports each end of the pallet and each dolly is secured to the deck of the pallet by the locking devices. The pallet may be a nestable half-size pallet.

### BRIEF DESCRIPTION OF THE DRAWINGS

FIG. 1 is a perspective view of two dollies according to one embodiment.

FIG. 2 is a side view of the dollies of FIG. 1.

FIG. 3 is a top view of the dollies of FIG. 1.

FIG. 4 is a perspective view of a pallet according to one embodiment.

FIG. 5 is a side view of the pallet of FIG. 4.

FIG. 6 is a top view of the pallet of FIG. 4.

FIG. 7 is an end view of the pallet of FIG. 4.

FIG. 8 is a perspective view of the pallet of FIG. 4 supported on the dollies of FIG. 1.

FIG. 9 is a perspective view of the pallet, partially broken away, on one of the dollies, with the locking device in a retracted, unlocked position.

FIG. 10 shows the pallet and dolly of FIG. 9 with the locking device partially removed from a retracted position.

FIG. 11 shows the pallet and dolly of FIG. 9 with the locking device being rotated toward the locked position.

FIG. 12 shows the pallet and dolly of FIG. 9 with the locking device rotated into alignment with the notch on the pallet.

FIG. 13 shows the pallet and dolly of FIG. 9 with the locking device in the retracted, locked position in the notch on the pallet.

FIG. 14 is a top view of the pallet and dolly of FIG. 13.

FIG. 15 is a side view of the notch portion of the pallet of FIG. 4.

FIG. 16 is a side view of an alternate receptacle for receiving the locking device in the pallet.

FIG. 17 is an exploded view of the locking device.

FIG. 18 is an assembled view of the locking device.

### DETAILED DESCRIPTION OF A PREFERRED EMBODIMENT

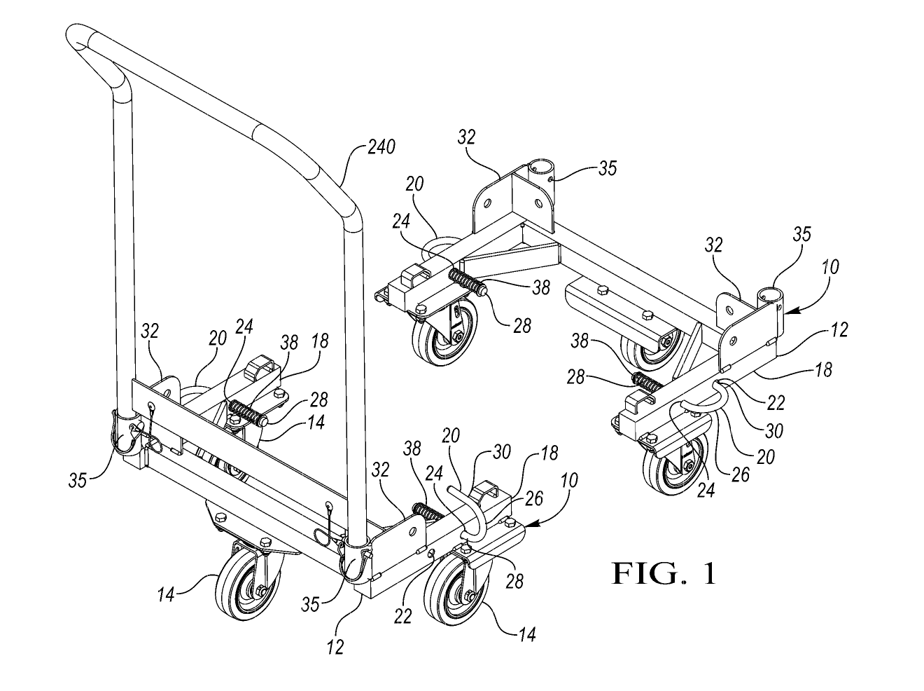

FIG. 1 is a perspective view of two dollies 10 according to one embodiment. Generally two such dollies 10 would be used together, one at each end of a pallet, as will be shown later. Each dolly 10 includes a base 12 having casters 14 (in this example, three) supporting the base 12. The base 12 includes a pair of sidewalls 18 extending upward from the casters 14. A corner flange 32 extends upward from the two end corners of the base 12. Brackets 35, such as the cylindrical brackets shown, may be formed in the corners of the dolly 10, for optionally mounting a handle 240. A handle 240 is shown mounted in one of the dollies 10.

The base 12 includes at least one locking device 20. In this example, the locking device is secured to each sidewall 18. The locking device 20 in this example is a J-shaped pin 20 including a long portion 28, a center portion 26 and a short portion 30. The long portion 28 is secured in an aperture 24 through the sidewall 18 and the short portion 30 may be temporarily received in a second aperture 22. A spring 38 biases the pin 20 toward an interior of the dolly 10. In FIG. 1, one of the pins 20 is shown in a retracted, locked position and the others are shown in a retracted, unlocked position.

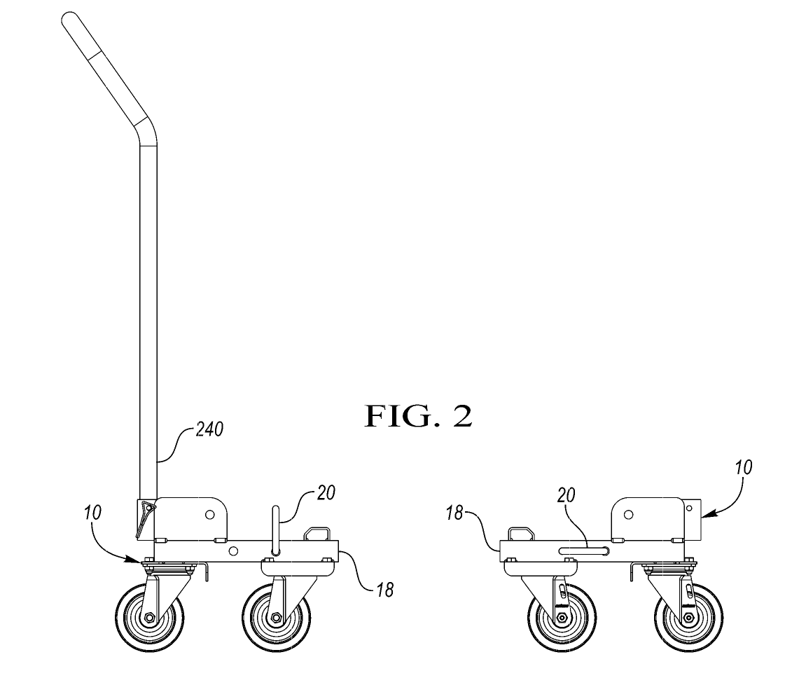

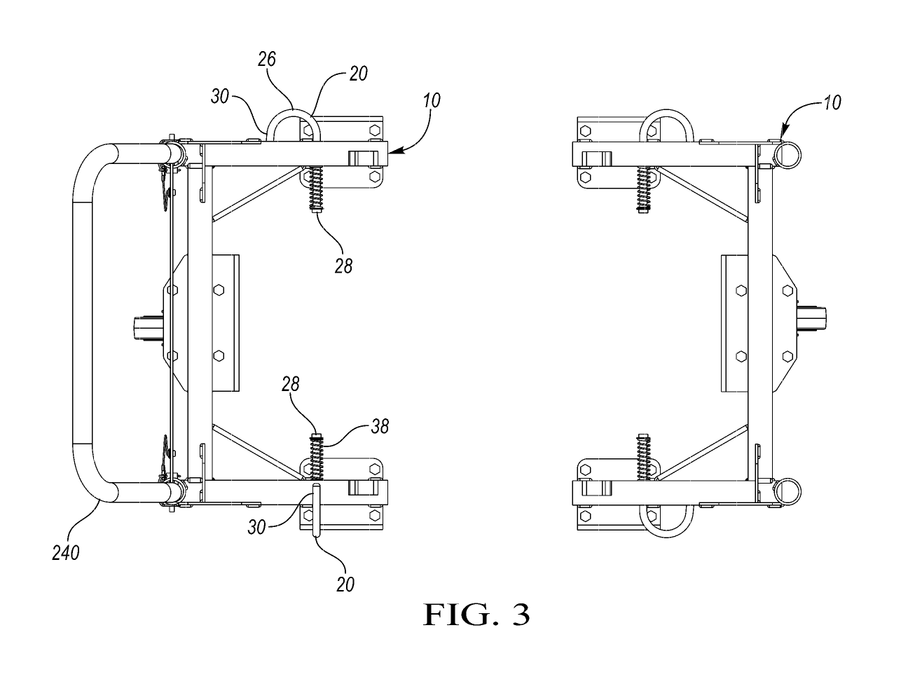

FIG. 2 is a side view of the dollies 10 of FIG. 1. Again the pin 20 on the left is shown in a retracted, locked position and the pin on the right 20 is shown in a retracted, unlocked position. FIG. 3 is a top view of the dollies 10 of FIG. 1.

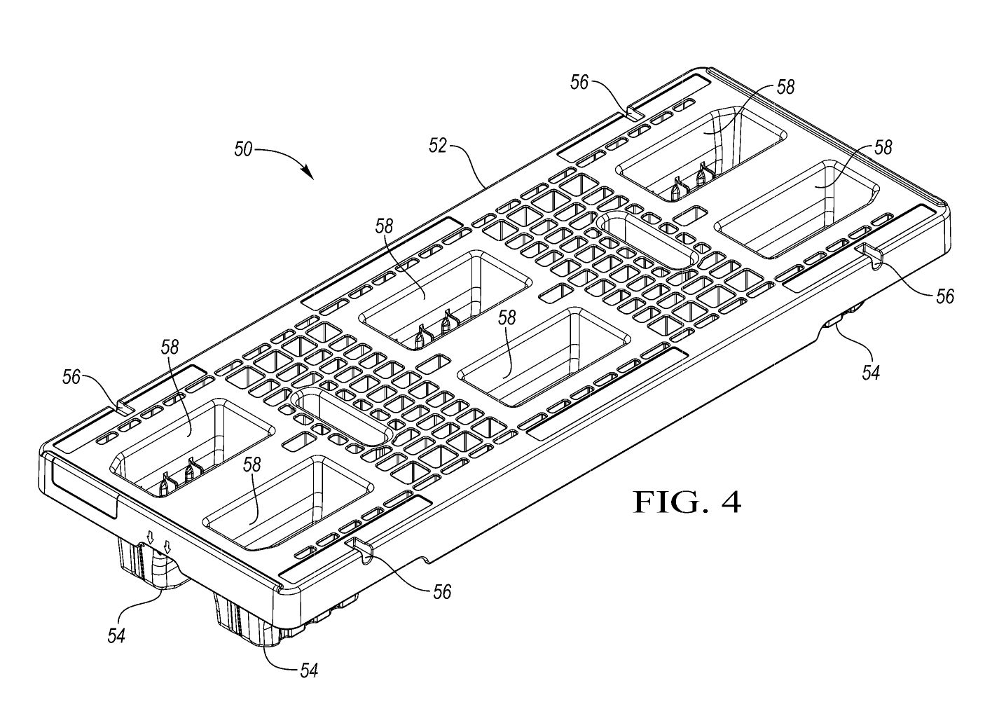

FIG. 4 shows a pallet 50 having a deck 52 and supports 54 extending downward from the deck 52. The deck 52 is a nestable pallet, i.e. there are openings 58 in the deck 52 for receiving the supports 54 of an identical pallet nested thereon (as is known). The pallet 50 in this example is a half-size pallet.

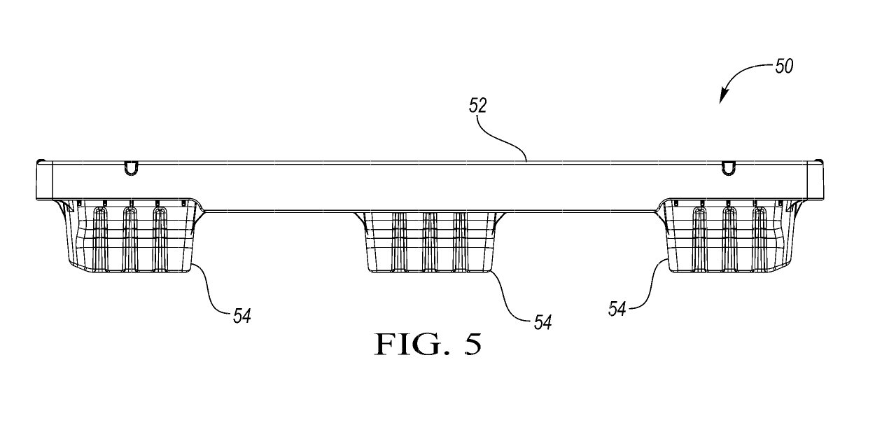

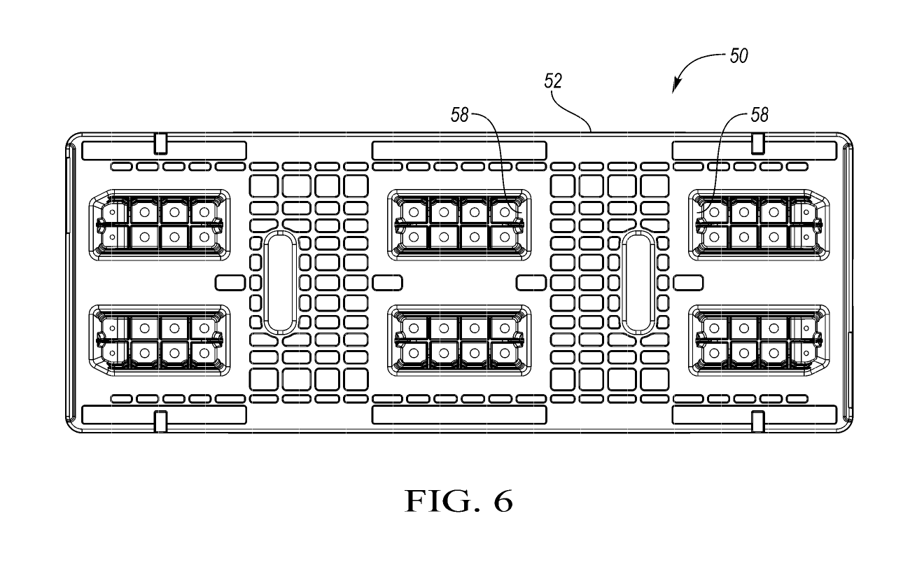

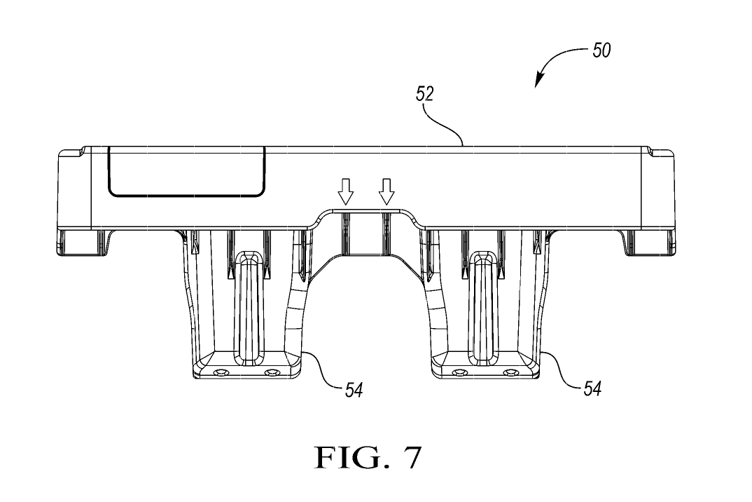

In this embodiment, the deck 52 of the pallet 50 includes an interlocking feature, such as a receptacle, in this case a notch 56, for receiving the locking device 20 of the dolly 10. Each notch 56 is formed along a side edge of the deck 52 and is open upward and to the exterior of the deck 52. Optionally, the deck 52 may include four notches 56, two on each long edge, with one adjacent each end of the pallet 50, as shown in FIG. 4. FIG. 5 is a side view of the pallet 50. FIG. 6 is a top view of the pallet 50. FIG. 7 is an end view of the pallet 50.

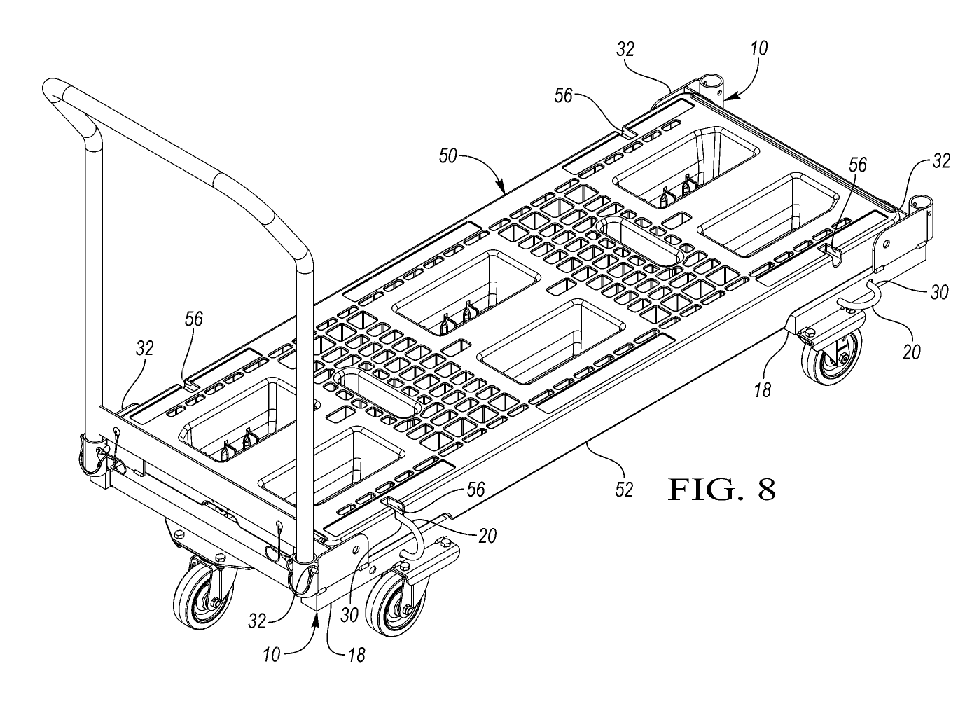

In FIG. 8, the pallet 50 is shown supported on the two dollies 10. One of the pins 20 is shown in the locked, retracted position with the short portion 30 received in the notch 56 in the deck 52. The deck 52 is received between the corner flanges 32 and supported on the side walls 18. The other pins 20 would be pulled out (against the spring) and then rotated upward to the notch 56 and then released into a retracted position in the notch 56. This secures the pallet 50 to the dollies 10.

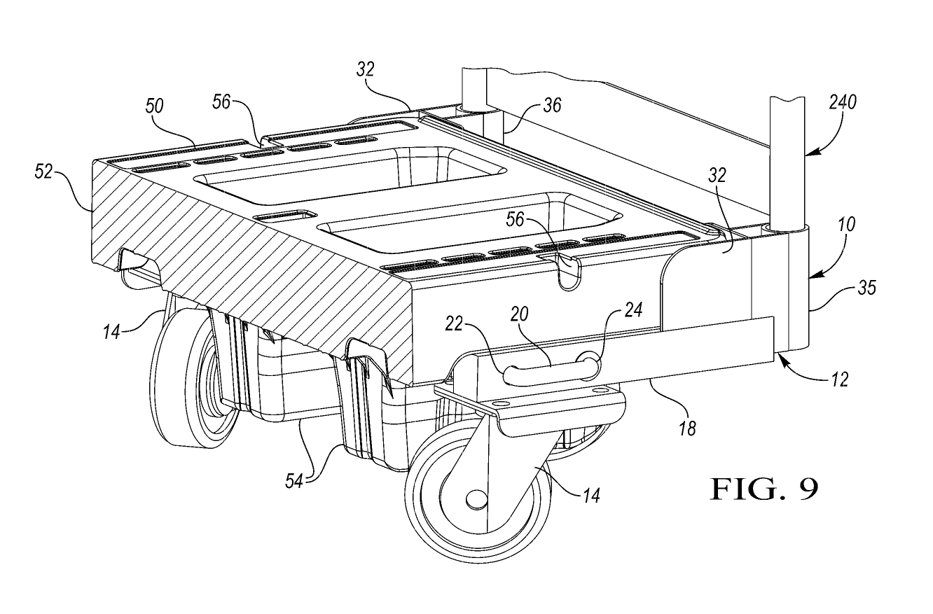

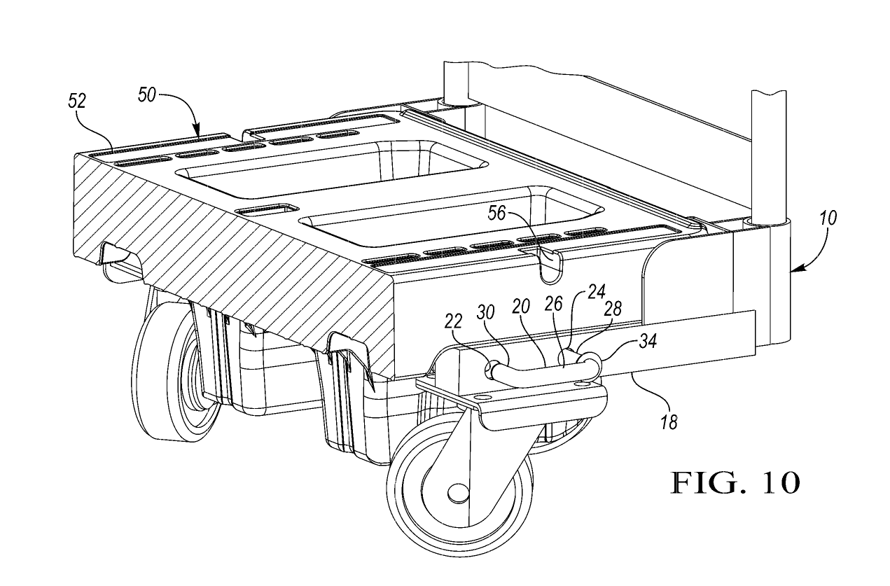

FIG. 9 is an enlarged view of one of the corners of the pallet 50 and one of the dollies 10 of FIG. 8. In FIG. 9, the locking device 20 is shown in its retracted position, to which it is spring-biased. In FIG. 10, the locking device 20 has been pulled outward from sidewall 18, against the spring. As shown, the locking device 20 is a J-shaped pin having the center portion 26, the long portion 28 at one end of the center portion 26 and the short portion 30 at the other end of the center portion 26. The long portion 28 is received in the aperture 24 in the sidewall 18 and has a flange 34 formed or secured thereto. The short portion 30 is receivable in the other aperture 22 in the sidewall 18 (but withdrawn in FIG. 10).

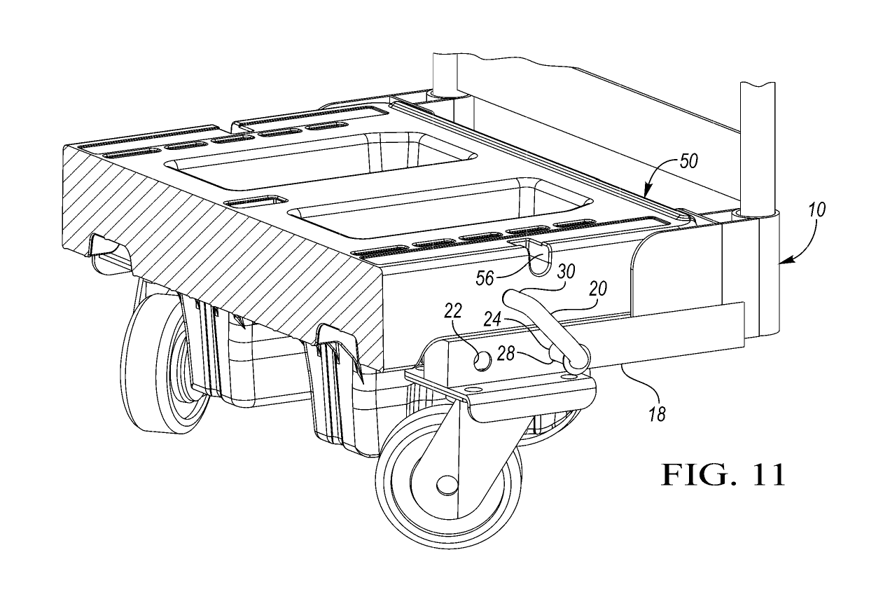

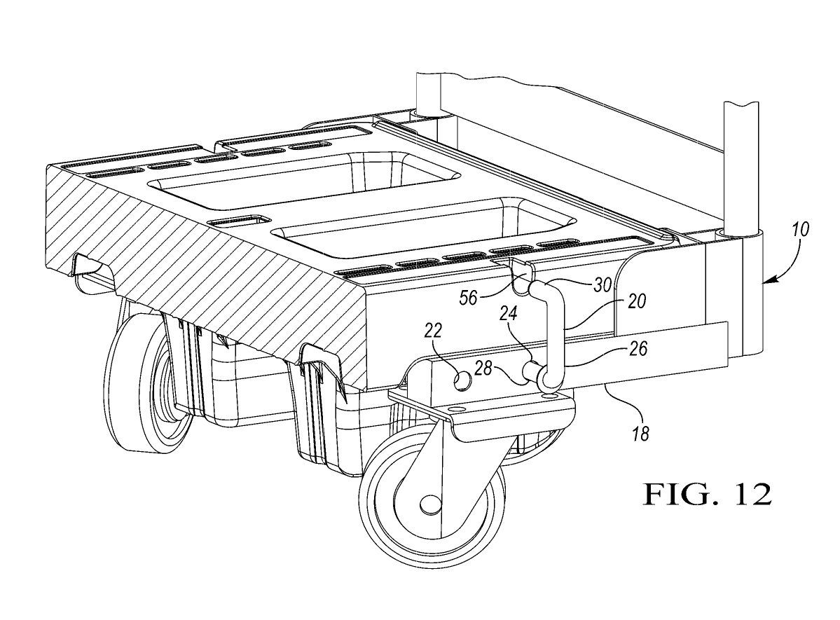

After the short portion 30 is removed from the aperture 22, the locking device 20 can be rotated on the long portion 28 within the aperture 24, as shown in FIG. 11. As shown in FIG. 12, the locking device 20 is rotated upward to alignment of the short portion 30 with the notch 56.

Referring to FIG. 13, when the locking device 20 is released, the spring biases the long portion 28 back into the aperture 24, which slides the short portion 30 into the notch 56 of the deck 52, thereby locking the pallet 50 to the dolly 10. The locking device 20 would be operated in the same manner on the other side of the deck 52 and twice more on the opposite dolly 10.

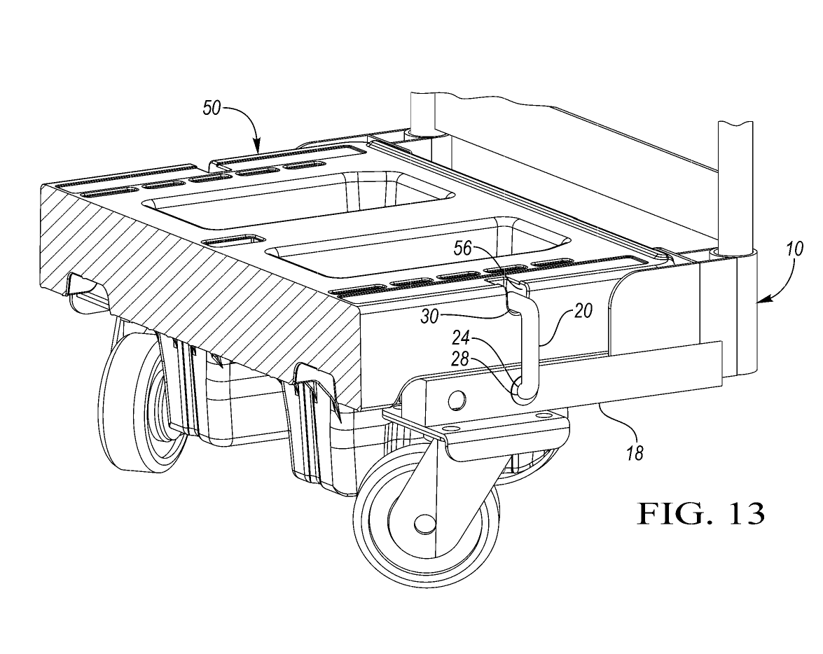

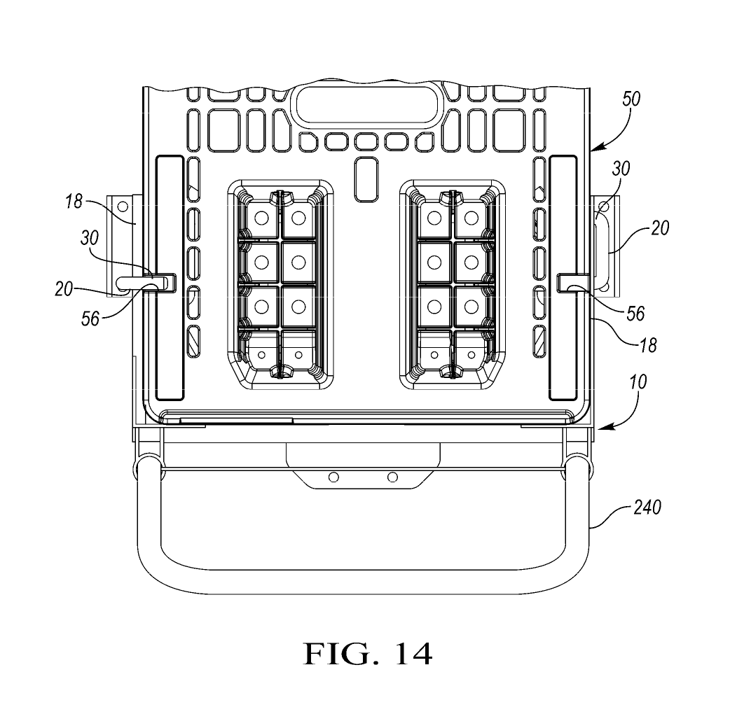

FIG. 14 is a top view of the dolly 10 connected to the pallet 50. One locking device 20 (on the left) is in the locked position with the short portion 30 within the notch 56. The other device 20 (on the right) is in the retracted position.

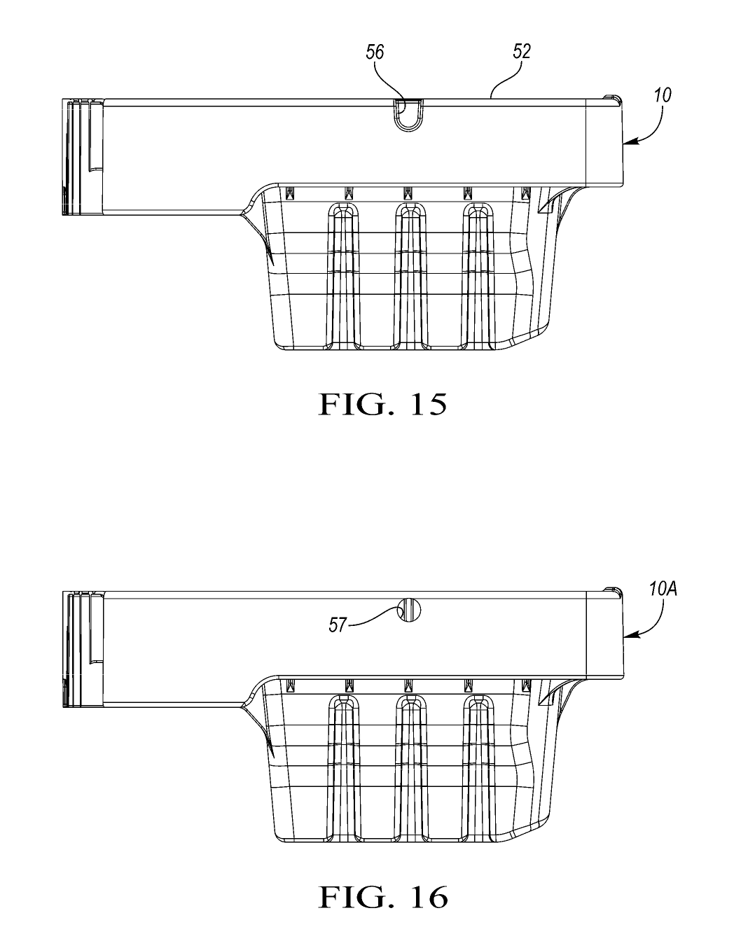

FIG. 15 is a side view of the portion of the pallet 50, showing a side view of the notch 56, which could be molded into the pallet 50 when the pallet 50 is molded. Alternatively, as shown in FIG. 16, an alternative receptacle, an aperture 57, could be formed or drilled into the deck 52.

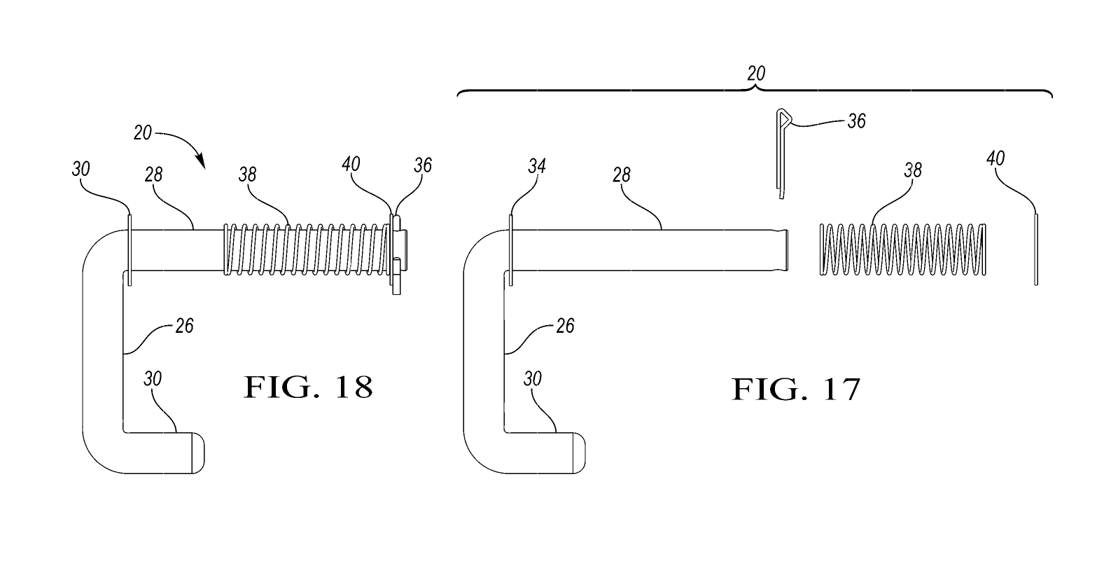

FIG. 17 is an exploded view of the locking device 20 according to one example. The locking device 20 includes a J-shaped pin including the long portion 28, the center portion 26 and the short portion 30. The device 20 includes a cotter pin 36 (or other fastener), a spring 38 (or other biasing member) and a washer 40. The flange 34 could be a washer tack-welded to the long portion 28.

The device 20 is assembled as shown in FIG. 17A. The spring 38 is captured on the long portion 28 by the washer 40, which is retained by the cotter pin 36 (or another fastener).

With the disclosed dollies 10, a user can easily secure, move and later remove a pallet 50.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A dolly comprising:
a base;
a plurality of wheels supporting the base; and
at least one locking device for removably securing a pallet to the base.

2. The dolly of claim 1 wherein the at least one locking device includes a pin for securing the pallet between the pin and the base.

3. The dolly of claim 2 wherein the pin is a J-shaped pin.

4. The dolly of claim 3 wherein the at least one locking device includes a spring biasing the pin into a locked position.

5. The dolly of claim 1 further including at least one corner flange for receiving a deck of the pallet.

6. The dolly of claim 1 further including at least one bracket for receiving a handle.

7. The dolly of claim 6 further including a handle having an elongated vertical portion received in the at least one bracket.

8. The dolly of claim 1 further including a pallet having a deck and a plurality of supports below the deck, the deck secured between the at least one locking device and the base.

9. The dolly and pallet of claim 8 wherein the dolly is a first dolly supporting one end of the pallet and further including a second dolly supporting a second end of the pallet, wherein the second dolly is secured to the deck of the pallet by at least one locking device.

10. The dolly and pallet of claim 8 wherein the at least one locking device is at least one pin and wherein the deck includes at least one receptacle for receiving the at least one pin.

11. A pallet comprising:
a deck having at least one receptacle for receiving a locking device from a dolly; and
a plurality of supports extending below the deck to support the deck.

12. The pallet of claim 11 wherein the deck includes a plurality of openings for receiving the supports of an identical pallet, such that the pallet is a nestable pallet.

13. The pallet of claim 11 wherein the at least one receptacle is at least one notch an upper edge of the deck.

14. The pallet of claim 13 wherein the at least one notch is open upward and open to the side of the pallet.

15. The pallet of claim 11 wherein the at least one receptacle is an aperture open to the side of the pallet.

16. The pallet of claim 11 secured to a dolly having a base supported by wheels, the dolly including a locking device received in the at least one receptacle to secured the deck between the locking device and the base.

17. The pallet and dolly of claim 16 wherein the dolly is a first dolly supporting one end of the pallet and further including a second dolly supporting a second end of the pallet.
